(19) United States
(12) Patent Application Publication
(10) Pub. No.: US 2002/0198866 A1
(43) Pub. Date: Dec. 26, 2002

(54) Credibility rating platform

(76) Inventors: Reiner Kraft, Gilroy, CA (US); Joerg Meyer, Campbell, CA (US)

Correspondence Address: PERMAN & GREEN, 425 POST ROAD, FAIRFIELD, CT, 06430, US

(21) Appl. No.: 09/805,808

(22) Filed: Mar. 13, 2001

(51) Int. Cl. G06F 7/00

(52) U.S. Cl. 707/3

(57) ABSTRACT

A system for associating a credibility rating with a document located in an online search. The system comprises an information gathering device adapted to retrieve the document from an information source, an information analysis device adapted to determine an online id associated with the document, and a credibility rating system adapted to provide the credibility rating associated with the online id to the information analysis device. The system is adapted to allow a user to retrieve the credibility rating associated with the document.

### BACKGROUND OF THE INVENTION

1. Field of the Invention

The present invention relates to Internet and web technologies and, more particularly, to enhancing the quality of Internet search technology.

2. Brief Description of Related Developments

The Internet, and the World Wide Web (“WWW”) in particular, are tremendous sources of information. Information of almost any type can be found on the Web. This information can also be referred to as “content” and almost all of the content on the Web can be linked to an online identity or identifier, referred to herein as an “online id.” An online id can comprise any Web or internet user, which can be for example, a person or an organization. Typically, an online id is represented through user identifiers (“user ids”), which can include for example, e-mail addresses. Since Web content is not generally subject to verification, censorship or any other means of control through regulatory or government agencies, just about any kind of information can be put up, or posted on the Web. Making information available on the Web is commonly referred to as “put up” or “posted” on the Web. Because of the randomness of the information and the entity that posts the information, it can be (and often times it is) extremely difficult to judge whether the Web content represents a reliable, credible and trustworthy source of information. Generally, there is very little certainty as to whether the information the reader or user finds in an Internet search is reliable, or whether the author of the found information is credible. In some cases, the information may be entirely worthless. However, if it were possible to obtain information or data about the owner or author of the Web content, a user who is looking at the Web content might be able to better judge the validity and usefulness of the content. Background information such as the author's profession or reputation in a particular domain or subject matter (e.g., stock market, politics, etc.) can be very valuable in this regard. Generally, it is difficult to obtain such background information and therefore, it is difficult to judge the value of the information derived from various authors or sources of content. In order to make it easier for Web users to judge the value of Web content, it would be helpful to have a mechanism for quickly obtaining background or credibility information of an author or online id associated with the content. It would also be helpful to be able to build up or develop a “reputation” for an online id that is accessible by Web or Internet users. A “reputation” can be used to indicate the general credibility or reliability of information posted by an author over time.

For example, if a user desires information such as financial news about the stock market, the user can conduct an Internet search on that topic. Several financial web sites (e.g. Yahoo!™ Finance™, E*TRADE™, etc.) offer discussion forums or chat rooms where people can talk in an electronic or online fashion about the stock market and other investment topics. Each person or entity is represented or identified in the discussion forum with an online id. An online discussion could also involve one of the online ids, an author, making a prediction about for example, the stock market, such as whether it is a good time to buy or sell specific stocks. One could imagine that this kind of information might be very valuable for decision building. However, the reader or user will not know the credibility of the online id that posted or authored the information, the history of other predictions by the online id that posted the information, or the overall quality of subject matter content of information authored by the online id that posted the information.

For example, referring to FIG. 1, a listing of messages posted on a Yahoo!™ Finance pages is shown. Each posted message is identified by its “Subject”, “Author”, and “Date/Time” that the message was posted. An author with the online id of “megacash2u” posted a message with the subject header of “IBM TARGET $230 GET READY TO FLY.” If a user reading this message could verify the credibility of the online id, and the history of predictions by the online id, the overall potential value of the message might be high.

Another aspect of credibility problems related to online ids are encountered on various auction sites. Here, the credibility history might already be available for particular areas (e.g. ebay™ auction feedback. However, a user might use different online identities on various websites. This could lead to the problem that while the credibility rating for an author at one particular site (e.g. eBay™) might be good, at a different site (e.g. Amazon.com™), the same user using a different online id, could have an overall bad rating. This represents a risk for people who make decisions based on solely one global id. If the other online ids used by the same person are mapped to the global id, people would be able to get a complete picture of the used online id.

### SUMMARY OF THE INVENTION

The present invention is directed to, in a first aspect, a system for associating a credibility rating with a document located in an online search. In one embodiment, the system comprises an information gathering device adapted to retrieve the document from an information source, an information analysis device adapted to determine an author of the document, and a credibility platform adapted to provide the credibility rating associated with the author to the information analysis device. The system is preferably adapted to allow a user to retrieve the credibility rating associated with the document.

In one aspect, the present invention is directed to a credibility rating system. In one embodiment, the system comprises a user interface adapted to allow an owner of an online id to input credibility information into the system for validation and write the validated information into a credibility information database. An input validator is coupled to the user interface and adapted to verify that the inputted credibility information is correct and to rate the inputted credibility information in the form of a credibility rating. The credibility database is preferably adapted to store the on-line identifier and the associated credibility rating. An application service interface is adapted to allow a third party to access the credibility rating.

In another aspect, the present invention is directed to a method of associating a credibility rating with a document retrieved in an Internet search. In one embodiment, the method preferably comprises determining an online id associated with the document and querying a credibility rating system for a credibility rating of the online id associated with the document. Preferably, a credibility rating vector for the document is computed using the rating from the credibility rating system and the credibility rating vector is stored in a searchable index.

In a further aspect, the present invention is directed to a computer program product. In one embodiment, the computer program product comprises a computer useable medium having a computer readable program code device embodied therein for causing a computer to associate a credibility rating with a document located in an online search. Preferably, the computer readable program code device in the computer program product comprises a computer readable program code device for causing a computer to retrieve the document from an information source, a computer readable program code device for causing a computer to determine an online id associated with the document and a computer readable program code device for causing a computer to retrieve a credibility rating associated with the online id and allow a user to access the credibility rating.

In another aspect, the present invention is directed to an article of manufacture. In one embodiment, the article of manufacture comprises a computer useable medium having a computer readable program code device embodied therein for causing a computer to associate a credibility rating with a document located in an online search. Preferably, the computer readable program code device in the article of manufacture comprises a computer readable program code device for causing a computer to retrieve the document from an information source, a computer readable program code device for causing a computer to determine an online id associated with the document and a computer readable program code device for causing a computer to retrieve a credibility rating associated with the online id and allow a user to access the credibility rating.

### BRIEF DESCRIPTION OF THE DRAWINGS

The foregoing aspects and other features of the present invention are explained in the following description, taken in connection with the accompanying drawings, wherein:

FIG. 1 is an exemplary search result page of an online or Internet search.

FIG. 2 is a block diagram of a system incorporating features of the present invention.

FIG. 3 is a block diagram of one embodiment of a system incorporating features of the present invention.

FIG. 4 is a block diagram of another embodiment of a system incorporating features of the present invention.

FIG. 5 is a table depicting an exemplary association of author (online id) with domain/rating results.

FIG. 6 is a block diagram of an apparatus that can be used to practice the present invention.

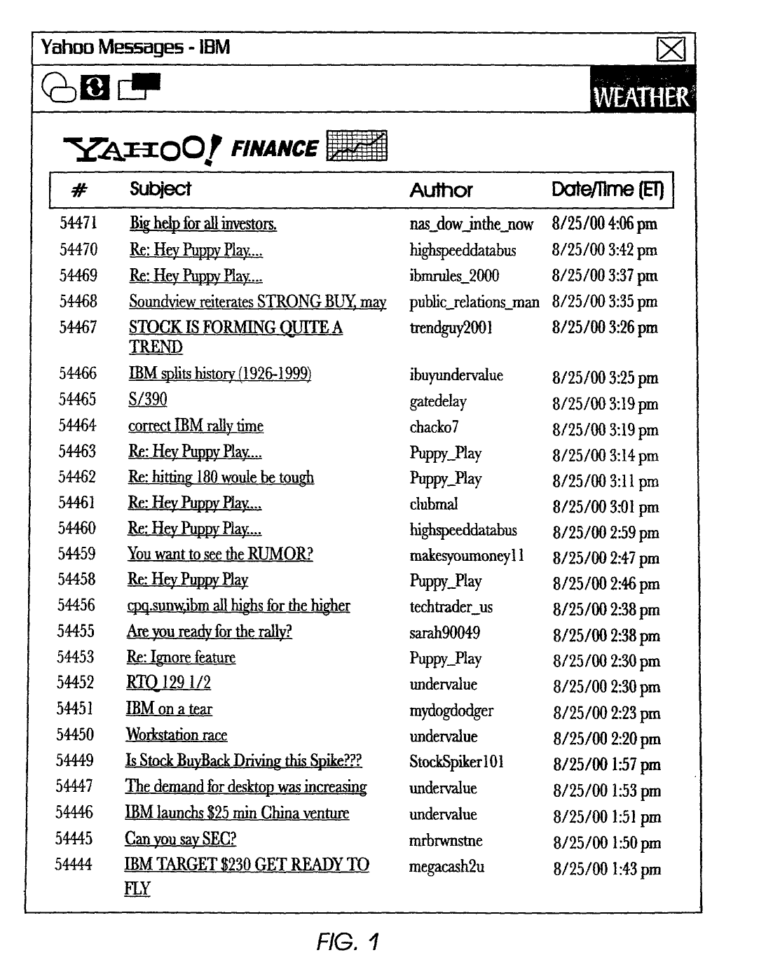

### DETAILED DESCRIPTION OF THE PREFERRED EMBODIMENT

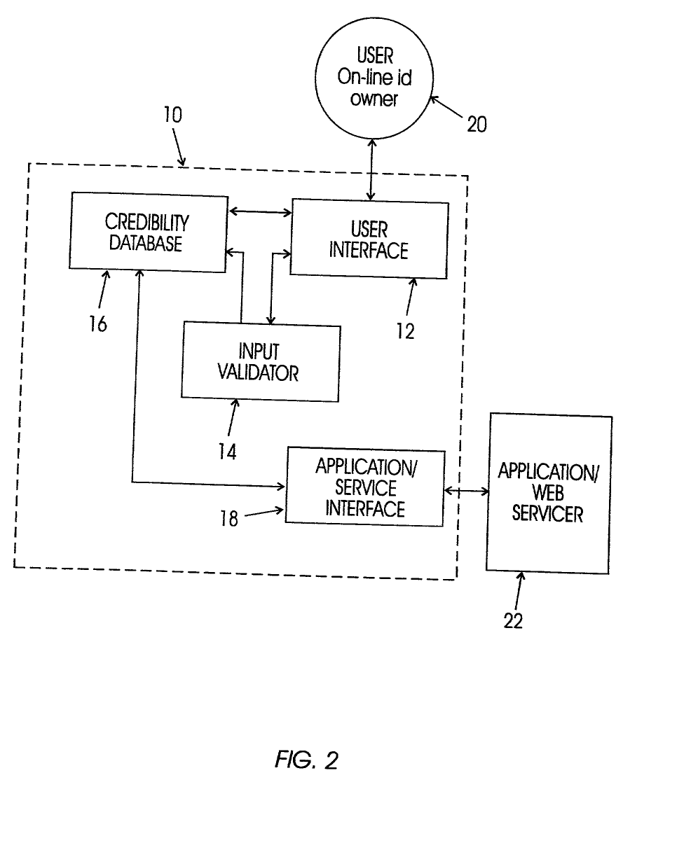

Referring to FIG. 2, there is shown block diagram of a system 10 incorporating features of the present invention. Although the present invention will be described with reference to the embodiment shown in the drawings, it should be understood that the present invention could be embodied in many alternate forms of embodiments.

Referring to FIG. 2, a system 10 for determining the credibility rating for an online id is shown. In one embodiment, the system 10 can comprise a user interface 12, and input validator 14, a credibility database 16, and an application/service interface 18. In an alternate embodiment, the system 10 can include such other suitable components or applications adapted for determining and storing credibility rating information for an online id. It is a feature of the present invention to provide a credibility rating platform or system that creates, stores, maintains and modifies information related to or about an online id, including an associated credibility rating.

As used herein, the term “online id” or “user id” generally refers to a name, moniker or acronym that is associated with, or used to identify, a person or entity on a computer network, such as, for example, the Internet. Generally, web pages are the most common form of information source on the Internet. As used herein, the terms “document” or “content” are used to refer generally to web pages and the information contained therein. “Content” can be the constituent information of a website or other source and can include text, sound, video, animation and numerical information. Bulletin boards and systems for posting electronic messages, storing files and chatting with other users can also be sources of “documents” or content. A person or entity engaged in a chat room will generally have an online identifier for identification and communication purposes. It will be understood by those of skill in the art that the present invention can be applied to any “online” or electronic source of information, and is not limited to the Internet or such applications.

The user interface 12 is generally adapted to support the interaction between the author or owner 20 of an online identifier and the credibility rating system 10. It is a feature of the present invention to allow an author or user 20 to input information related to the credibility of a document or the author's credibility, or credibility profile. The system 10 is adapted to evaluate this information in developing a credibility rating for the author and the associated content.

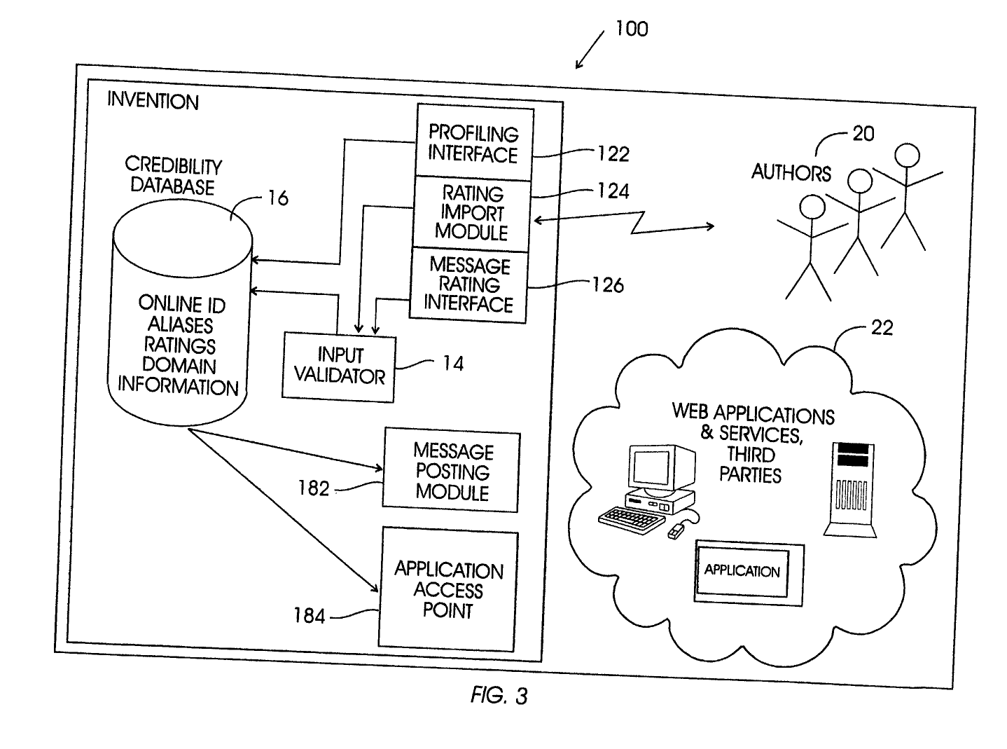

In one embodiment, as shown in FIG. 3, the user interface 12 can include three modules, the profiling interface 122, the rating import module 124, and the message rating interface 126. The rating import module 124 and the message rating interface 126 can both use the input validator 14 to verify the correctness of an input by the author 20 and to rate that information. An input by an author 20 can generally comprise information related to the content of a web page, and can include for example, supporting statements, references or other sources of validation for the information content. Generally, the user interface 12 can be entirely Web based and accessed through standard Web browsers, such as, for example, Netscape™ or Internet Explorer™. Generally, the user interface 12 is adapted to receive information in a structure form. For example, the information inputted by a user will be in the form of predetermined data fields, where each data field has a predetermined structure and meaning. The information entered into each data field can then be evaluated for correctness as to form and structure. Using the data fields, the input can be evaluated for accuracy and weight, and used in developing the credibility rating.

The application/service interface 18 is generally adapted to allow third parties 22 access to the credibility rating system 10. A third party, as referred to herein, generally comprises any person or entity that has accessed or obtained online information and now desires to ascertain a value of the information using the credibility rating of the author. In one embodiment, as shown in FIG. 3, the application/service interface 18 can comprise a message posting module 182 and an application/access point 184. As shown in FIG. 2, both the user interface 12 and the application/service interface 18 are adapted to interact with the credibility database 16, which is adapted to hold and associate the available online ids and related information, such as for example ratings and domains specific information. The application/service interface 18 can also be Web based, but different messaging and interface protocols are possible.

Referring to FIG. 3, the profiling interface 122 is generally adapted to allow authors 20 to create and maintain themselves an online credibility rating. As used herein, the term “users” can include for example one or more persons or entities that provide information over the web and have an associated online id. An online credibility rating is associated with a unique credibility online id (“COI”), and the COI is used to access an author's credibility rating. The profiling interface 122 allows the mapping of the author or user identifiers to the COI. In one embodiment, the author can input the various online ids used by the author. In an alternate embodiment, and search engine or similar device or “robot” could be used to automatically search for, and retrieve online ids associated with an author from different sources. As used herein, the term “Author Identifiers or ID” is generally used to refer to, for example, an e-mail address of the author. The profiling interface 122 can allow an author 20 to have different kinds of ratings that are domain on subject matter specific. For example, the author 20 can have a credibility rating for a domain that includes the stock market, and another credibility rating for a domain that is directed to politics. The profiling interface 122 can also be where the author 20 can specify which third parties 22 may access the author's rating information stored in the credibility data base 16 and what other forms of ratings may be combined with the author's credibility rating. Generally, the profiling interface 122 allows the author 20 to create and modify his or her preferences of how to handle the associated COI and rating information.

The message rating interface 126 is adapted to allow the author 20 to affect the associated credibility rating. The message rating interface 126 allows the author 20 to input statements related to a topic of a particular domain. Generally, the statements are inputted in a structured format using predetermined data fields. Each data field can be formatted to accept specific types of information and data that can be evaluated by the system. The input validator 14 can analyze the statement and the result of the input validator 14 analysis can be stored and incorporated into the overall credibility rating of the author 20 who issued this statement. The analysis by the input validator 14 would generally lead to a conclusion that either the statement is correct or incorrect. A correct statement can, in some cases, positively affect the credibility rating of the author, whereas an incorrect statement can negatively affect the author's credibility rating. Generally, the message rating interface 126 is adapted to accept statements from an author that are constructed through rigid forms that provide domain specific choices. For example, if the domain is the stock market, and an author 20 wants to make a prediction about the share price of a particular stock, the message rating interface 126 is adapted to provide the author a form that can include fields that lets the author 20 input, for example, the stock symbol, the predicted price and the date on which this prediction should be evaluated. The message rating interface 126 is adapted to evaluate and analyze the inputted information in each field and weigh and rate each piece of information. Since some things are more difficult to predict than others, such as for example the predicted stock price tomorrow versus a year from now, the message rating interface 126 can be adapted to weigh a statement according to the date input and the domain. For example, in the case of a stock price prediction, the length of time period covered by the prediction as well as the difference between the current and the predicted stock price can be used to determine the weight of the statement. In alternate embodiments, the information or data can be combined in any desired manner in order to analyze the information and develop the credibility rating. The concept of weighted statements assures that more difficult, correct statements can have a greater positive impact on the rating rather than very simple, correct statements. On the other hand, simple, incorrect statements can have a greater, negative impact on the rating than incorrect, but more difficult statements. The message rating interface 126 is adapted to rate a message as soon as a validation is possible. For example, in the case of the stock price prediction example, the first possible date to examine the statement may be the date for which the prediction was made. The input validator 14 can handle this scheduling job.

The present invention allow users to enter their data using rigid, structured forms. This enhances the accuracy of verifying their information or predictions. The same information does not have to be entered time and time again. The user can automatically post the information that was used to build up the credibility profile, to a variety of online sources, such as, for example, newsgroups and bulletin boards, without having to reenter the information.

Referring to FIGS. 2 and 3, the system 10 can also include an input validator 14 that is generally adapted to perform an analysis of the statement or statements and verify the correctness of the statements. The input validator 14 is adapted to receive the inputted statements from the message rating interface 126 in a specific format and then validate the statements. This validation may require some sort of scheduling if the statements cannot be validated right away. For example, in the above mentioned stock price prediction, the statement is time dependent. If the statement cannot be validated right away, the statement can be stored in the a portion of the credibility database 18 for later validation. Once the input validator 14 has validated a statement, i.e. determined whether the statement is correct or not, the input validator 14 can use the validation information to update the credibility rating of the author 20 associated with the statement. The credibility rating can be updated according to factors including the validation result and the weight of the statement as determined by the message rating interface 126.

The input validator 14 can also be adapted to analyze external rating information inputted into the system 10 from external sources and different sites. This kind of information from different sites can generally be made available through the rating import module 124. In one embodiment, the input validator 14 can have a pluggable architecture for each domain or subject area. For example, the input validator 14 can have different modules for the stock market, politics, and sports. Each module can be adapted to format the information and statement according to the domain type. In one embodiment, for each external rating format, a conversion plug-in may be necessary. The input validator 14 can be adapted to communicate with the message rating interface 126 and the rating import module 124 and advertise the domains and rating formats it supports. This functionality will permit the author to make statements only within supported domains, and import ratings from supported formats/vendors.

The rating import module 124 is generally adapted to allow the author 20 to link credibility rating information from sources other than the credibility rating system 100 to the information already stored. For example, some Web sites such as ebay™ already keep a history/rating of a user's auctioning behavior. Through the rating import module 124, an author 20 can choose to enhance their rating information and profile and add external rating information from these other sources. The rating import module can be adapted to receive or retrieve this external information, and format the external information for use by the system 10. The rating import module 124 is generally adapted to communicate with the credibility database 16 through the input validator 14.

The message posting module 182 is generally adapted to allow the author 20 to post an author statement, such as for example a message, regarding or linked to their credibility rating and document. For example, if an author 20 makes a stock price prediction, the message posting module 182 can be adapted to automatically post this information to brokerage sites where the author 20 may have an account, or to a stock discussion forum that the author participates in. The different web pages associated with the author 20 can be linked to the credibility online id of the author 20 through the profiling interface 122. In one embodiment, the message posting module 182 can be adapted to be an information push mechanism.

The application access point 184 generally represents the communication point for users other than the author or third party services and applications 22 to request credibility ratings for or associated with an online identifier. For example, an online brokerage site that has a discussion forum could retrieve and display the credibility rating of authors 20 who have posted messages to a discussion forum. Since the system 100 supports aliases, such as for example, mapping of user identifiers to the credibility online id, the third party applications 22 can request information through the application access port using different identifiers.

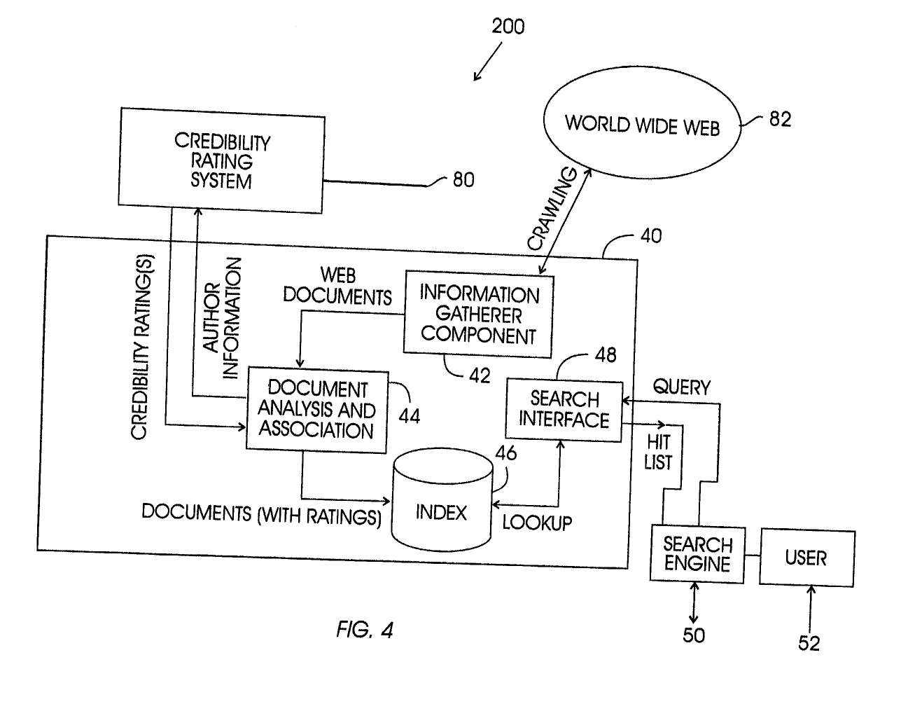

Referring to FIG. 4, a system 200 can be used to enhance a search result set by associating credibility ratings to information pieces and reordering the search result set based on the credibility information. In one embodiment as shown in FIG. 4, a credibility rating system or platform 80 can be used to allow third parties to access the rating associated with online ids and to push information from online ids to applications and Web sites. The system or device 40 is adapted to calculate a credibility score or rating for a document or information piece and associate the score with the information piece. The system 40 can also be adapted to automatically filter information to select quality information pieces. In one embodiment, the system 40 can comprise an information gatherer component 42, a document analysis and association device 44 a searchable index 46, and a search interface 48. The system 40 is generally adapted to interface with an information portal, such as for example, the World Wide Web, and a credibility rating system or platform 80. In alternate embodiments, the system 200 can include any suitable components that allows a search result set to be organized based on a credibility rating of the information or the author of the information. It is a feature of the present invention to enhance a search result or search result set (a “hit list”) by associating credibility ratings assigned by, for example, a credibility rating system 80, to information pieces and then reordering the search result list based on the credibility ratings. Typically, an Internet search returns a search result set, also called a “hit list.” A “hit list” can be very large and cumbersome to work with, and may include many irrelevant documents. The present invention allows the information pieces to be indexed according to a credibility rating.

Generally, the system 200 is adapted to extract author information from the gathered documents in the search result set and consult a credibility lookup table, or rating system 80 to retrieve the associated author credibility rating. The hit list can then be reordered according to the ranking of the credibility information. An interface 48 can allow the user access to the documents and their ratings. In one embodiment, the documents can be identified by uniform resource locator's (“URL's”). The system 200 can be adapted to be used by existing search engines or incorporated into the indexing process of a search engine.

Referring to FIG. 4, the information gatherer component 42 is generally adapted to systematically crawl the Internet or other network resources, and forward retrieved documents or information to the document analysis and association device 44. The information gatherer component 42 could include for example a robot crawling component that is adapted to frequently visit Web sites and retrieve the documents or information available at those Web sites. A common technique to find out which documents can be accessed by a search engine index is to use a “Web Robot” to search and read the “robots.txt” file of a site. Generally, this file specifies which portions of a Web site are off limits for a search engine robot. A “robot” is generally a program that automatically traverses the Web's hypertext structure by retrieving a document, and recursively retrieving all documents that are referenced. Web robots can also be referred to as web wanderers, web crawlers or spiders. In alternate embodiments, any suitable device can be used retrieve and gather the documents. The documents that can be accessed are subsequently downloaded by the information gatherer component 42 and passed on to the document analysis and association component 44.

Since one of the features of this embodiment of the present invention is to associate credibility information with documents, the document analysis and association device 44 shown in FIG. 4 is generally adapted to analyze the document or information piece. The document analysis and association device 44 receives a document from the information gatherer component 42 and determines the author or online id of the document. In order to look up credibility information from the credibility rating system 80, the document analysis and association device 44 is adapted to try to determine who is the author of the document or information piece. For example, if the document to be indexed is a hypertext mark up language (“HTML”) document, a static HTML page may contain meta data included in the <HEAD> tags of the HTML document. In one embodiment, a typical HTML file could look like this:

<HTML>

<HEAD>

<META NAME=“author”
CONTENT=“jmeyer@almaden.ibm.com”/>
<META NAME=“author”
CONTENT=“rekraft@almaden.ibm.com”/>
<TITLE>

Enhancing Internet Search Experience By
Associating Credibility Ratings to
Information Pieces

</TITLE>

</Head>

<BODY> </BODY>
</HTML>

The information encoded in the <META> tags can be extracted using a simple extensible mark up language (“XML”) HTML parser that provides access to the structure information within an HTML/XML page.

Once the author information is extracted from the document, the author information can be used to query the credibility rating system 80. The credibility rating system 80 generally allows access to the credibility rating developed for the online id by the system 80. In the above example of an HTML document, the document analysis and association device 44 is adapted to query the credibility rating system 80 with the two author identifiers found, jmeyer@almaden.ibm.com and rekraft@almaden.ibm.com. A document can have more than one author. The credibility rating system 80 is then adapted to return the rating information associated with the given identifiers, which can be the online id, provided that the authors are known to the credibility rating system 80 using these identifiers and not an alias. Once the author's credibility ratings are retrieved, an overall rating vector for the current document or information piece can be computed and stored in the searchable index. An example of a rating vector for an author/domain association is shown in FIG. 5.

Once the document analysis and association device 44 has extracted the author information, it can also try to retrieve credibility information associated with the author(s) of the current document. If the author or, in some cases authors, are know within the realm of the credibility rating system 80, a credibility information rating vector associated with the given author is returned. For example, consider a report about a publicly rated company written by two authors, “A” and “B.” Assuming both authors are known within the realm of the credibility rating system 80, the credibility rating system 80 may return the information in a format as shown in the table of FIG. 5. As shown in FIG. 5, the information returned for each author includes a domain 181 for the subject matter of the information and a rating 183 for that domain. For example, for author “A” in the domain “finance (stocks)” the system has returned a rating score of 110. For the domain “politics”, the rating score is 90. The document analysis and association device 44 is adapted to determine an overall rating score depending on the retrieved credibility rating information. For example, referring to the table of FIG. 5, the document associated with authors “A” and “B” could have an overall rating score or ranking of 95 in the domain “finance (stocks)” and an overall ranking of 92.5 in the domain of “politics.” The overall rankings are generally determined by computing the average of the values given for each domain. Depending on the focus of a particular implementation, different ratings for particular domains can be combined or omitted.

The searchable index 46 is generally adapted to store the association between documents for information pieces and the credibility ratings returned from the credibility rating system based on the documents authors. In one embodiment, the search index 46 can be adapted to map the document or information piece identifiers, such as for example a uniform resource locator to ratings. A search engine, which can create a hit list for a given query, could then access the information stored in the search index 46. As used herein, the term “query” is generally meant to include any request for information from a storage repository such as for example a database. Structure query language (“SQL”) is often used to construct queries. Most search engines like, for example, Altavista™ and Google™, do not use metadata to rank the pages in their search engines. Therefore, those hit lists are usually sorted by the number of occurrences of the query terms in the documents. In one embodiment of the present invention, a hit list can be sorted giving the URLs of the hit list and the information in the searchable index 46.

The search interface 48 is generally adapted to provide an access point for the search application to search the searchable index 46. For example, suppose a user 52 issued a query to a search engine 50 and the search engine produces a hit list R (result set) consisting of a number or URLs as shown below.

R={URL1, URL2, URL3, URL4, . . . , URLn}

Further suppose, that the searchable index 46 contains entries for URL2′ (95), URL3′ (80) and URL4′ (105), where the numbers in parenthesis represent the credibility rating of the document. Although this example shows a document having a single score, it should be understood that a document could be associated with more than one rating, also refer to as a rating vector. Using the hit list R and the rating information for URL2′, URL3′, and URL4′, the search engine can now reorder the hit list R using the ratings such that the document with the highest rating appears first in the hit list as R={URL4, URL2, URL3, URL1, . . . , URLn}.

In another embodiment, the credibility information for a document could be associated into a search engine indexing and page ranking process. Generally, search engines use a very simple method to rank pages. The page rank determines which pages come first in a hit list for a certain search query. These ranking methods do not consider the author and author's credibility as ranking criteria and the first hits in the hit list may or may not be of high value. In the present invention, the credibility information can be linked to the Web content and used for Web page ranking. The higher the credibility rating of the owner of the Web content, the higher the page rank of the Web content will be. Thus, the first hits in the page list returned by the search engine will have a higher value in terms of the author's credibility. The credibility information could be used to order the documents of a particular search engine while the search index is built. The searchable index 46 in this embodiment would then include more information than just the mappings of the documents to URLs. Additionally, the searchable index 46 could include information about terms, such as for example words, names and phrases, and their locations within the documents. In this embodiment, the search interface 48 could be adapted to allow the user to issue a query similar to the common web interfaces, such as for example HTML forms, of most search engines. Using the same query Q as in the previous example, the search engine would automatically return a hit list R, in which the URLs are sorted based upon the URLs credibility ratings.

The present invention generally provides for the ability for authors to set up a global online identifier that can be associated with an automatically processed credibility rating. The rating is dynamic and can be built up gradually over time and can also be subject to changes depending on the author's activity. The global online id can comprise an array of credibility ratings, including express domain specific credibility ratings. Thus a user with a global online id may have a high credibility rating in a stock market domain for example, but a poor credibility rating in a real estate domain. The present invention also provides the ability for an author to express opinions and make predictions that can automatically be verified to develop the credibility rating and rating profile. The use of generally rigid forms for data entry enhances accuracy for data interpretation and verification. Predictions, which are more difficult, can generally lead to higher credibility ratings. A point system could also be associated with predictions to express the level of credibility for an online id. Other online ids could be associated to the global online id, and credibility data from various other external sources can be automatically integrated into one global online id. External applications can also request the credibility rating of an online id from the system. Such a request could be for a global online id or another id, which would then be mapped to a global online id if available. A request could result in a credibility vector, which represents the current credibility of an author. Data that was entered by the author can be posted and processed within the credibility system to various other external communities including, for example, news groups and bulletin boards.

In another embodiment, the present invention provides the ability to automatically determine the author or authors of a document and automatically generate a quality rating for the document by associating a credibility rating retrieved from the credibility rating platform for the author. The association can then be stored either in a respository, or by adding it to the document as meta data. The present invention also allows a search engine's ranking algorithm to integrate the quality rating, such that it is possible to filter document lists or to change the order in which documents and lists are displayed based on user queries.

The present invention thus provides a system that is able to produce higher quality search result sets and can be used within vertical portals. For example the present invention could be used in a tightly focused content area geared toward a particular audience such as for example a woman's sport website, to enhance the overall search experience. In addition, the associated credibility quality rating of a document could be used by reader's software applications to provide hints to the reader of a document in terms of the usefulness information piece. A program could be used to display a “thumbs up” or “smiley”, for example if the document has a positive credibility background (high quality), or a different symbol, such as a “stop sign” or “thumbs down”, for a poor quality document. Although any desired program could be used, one example would be the Adobe Acrobat Reader™ program.

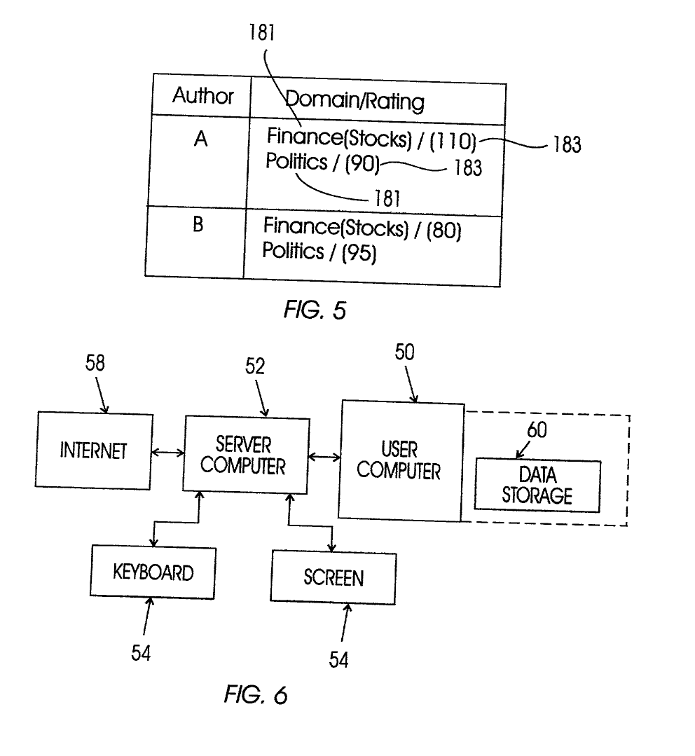

The present invention may also include software and computer programs incorporating the process steps and instructions described above that are executed in different computers. FIG. 6 is a block diagram of one embodiment of a typical apparatus that may be used to practice the present invention. As shown, a computer system 50 may be linked to another computer system 52, such that the computers 50 and 52 are capable of sending information to each other and receiving information from each other. In one embodiment, computer system 52 could comprise a server computer adapted to communicate with a network 58, such as, for example, the Internet. Computer systems 50 and 52 can be linked together in any conventional manner including a modem, hard wire connection, or fiber optic link. Generally, information can be made available to both computer systems 50 and 52 using a communication protocol typically sent over a communication channel, or through a dial-up connection or ISDN line. Computers 50 and 52 are generally adapted to utilize program storage devices embodying machine readable program source code which is adapted to cause the computers 50 and 52 to perform the method steps of the present invention. The program storage devices incorporating features of the present invention may be devised, made and used as a component of a machine utilizing optics, magnetic properties and/or electronics to perform the procedures and methods of the present invention. In alternate embodiments, the program storage devices may include magnetic media such as a diskette or computer hard drive, which is readable and executable by a computer. In other alternate embodiments, the program storage devices could include optical disks, read-only-memory (“ROM”) floppy disks and semiconductor materials and chips.

Computer systems 50 and 52 may also include a microprocessor for executing stored programs. Computer 50 may include a data storage device 60 on its program storage device for the storage of information and data. The computer program or software incorporating the processes and method steps incorporating features of the present invention may be stored in one or more computers 50 and 52 on an otherwise conventional program storage device. In one embodiment, computers 50 and 52 may include a user interface 56, such as, for example, keyboard and a display interface 54, such as for example a screen. In alternate embodiments, any suitable user interface and display interface can be used from which features of the present invention can be accessed. The user interface 56 and the display interface 58 can be adapted to allow the input of queries and commands to the system, as well as present the results of the commands and queries.

It should be understood that the foregoing description is only illustrative of the invention. Various alternatives and modifications can be devised by those skilled in the art without departing from the invention. Accordingly, the present invention is intended to embrace all such alternatives, modifications and variances that fall within the scope of the appended claims.

What is claimed is:

1. A system for associating a credibility rating with a document located in an online search comprising:
an information gathering device adapted to retrieve the document from an information source;
an information analysis device adapted to determine an online id associated with the document; and
a credibility rating system adapted to provide the credibility rating associated with the online id to the information analysis device, wherein a user can access the credibility rating associated with the document.

2. The system of claim 1 further comprising a searchable index adapted to store an association of the credibility rating of the online id with the document, wherein the association is accessible by a search engine.

3. The system of claim 2 wherein the searchable index is adapted to map a unique identifier associated with the document to the associated credibility rating.

4. The system of claim 1 wherein the document is a web page and the web page has a unique identifier comprising a uniform resource locator (“URL”).

5. The system of claim 1 wherein the online search is an Internet search and the document is retrieved from the Internet.

6. The system of claim 1 wherein the credibility rating system comprises:
a user interface adapted to allow an owner of the online id to input information into the credibility rating system that can be validated and write the information into a credibility database wherein the information is stored and associated with the online id;
an input validator coupled to the user interface and adapted to verify that the input by the owner is correct and to determine the credibility rating, the credibility rating reflecting the input; and
an application service interface adapted to allow a third party to access the credibility rating stored in the credibility rating system.

7. The system of claim 6 wherein the user interface further comprises:
a profiling interface adapted to allow a mapping of the online id to an online credibility rating;
a rating import module adapted to allow rating information from outside sources to be linked to the credibility database; and
a message rating interface adapted to allow the online id to input statements related to a validity of the document and determine a weight of the statement based on a statement analysis, the weight of the statement being used by the input validator to determine the credibility rating.

8. The system of claim 6 further comprising a message posting module coupled to the credibility database and adapted to allow the online id to distribute a message linked to the credibility rating and document to third parties.

9. The system of claim 7 further comprising an application access point coupled to the credibility database adapted to allow a third party to submit a query for the credibility rating associated with the online id.

10. A credibility rating system comprising:
a user interface adapted to allow an owner of an online id to input credibility information associated with a document into the system for validation;
an input validator coupled to the user interface and adapted to verify that the inputted credibility information is correct and to rate the inputted credibility information in the form of a credibility rating;
a credibility database adapted to store the on-line identifier and the associated credibility rating; and
an application service interface adapted to allow a third party to access the credibility rating from the credibility database.

11. The system of claim 10 wherein the user interface further comprises:
a profiling interface adapted to allow a mapping of the author identifier to an online credibility rating;
a rating import module adapted to allow rating information from outside sources to be linked to the credibility rating in the credibility database; and
a message rating interface adapted to determine a weight of the inputted credibility information based on a statement analysis of the inputted information.

12. The system of claim 10 further comprising a message posting module coupled to the credibility database and adapted to allow the author to distribute a message linked to the credibility rating and document to third parties.

13. The system of claim 11 further comprising an application access point coupled to the credibility database adapted to allow a third party to submit a query for the credibility rating associated with an online identifier.

14. A method of associating a credibility rating to a document retrieved in an Internet search comprising the steps of:
determining an online id associated with the document;
retrieving a credibility rating from a credibility rating system for the online id; and
associating the credibility rating with the document.

15. The method of claim 14 wherein the step of determining an online id of a document comprises the step of extracting an author information code from a header tag of an HTML document.

16. The method of claim 14, further comprising the step of developing a credibility rating for an online id, the method comprising the steps of:
receiving an input from the online id related to a credibility profile for the online id;
validating the input by determining a weight of the input;
assigning the credibility rating to the online id; and
storing the credibility rating in a searchable index.

17. The method of claim 15 further comprising the step of integrating the credibility rating vector into a search engine using a ranking algorithm.

18. The method of claim 14 further comprising the step of reordering a search result list comprising a list of documents returned from the Internet search relative to the credibility rating associated with each document.

19. The method of claim 16 further comprising the step of displaying a symbol on the information indicating the quality rating to the user.

20. A computer program product comprising:
a computer useable medium having a computer readable code device embodied therein for causing a computer to associate a credibility rating with a document located in an online search, the computer readable code device in the computer program product comprising:
a computer readable program code device for causing a computer to retrieve the document from an information source;
a computer readable program code device for causing a computer to determine an online id associated with the document; and
a computer readable program code device for causing a computer to retrieve a credibility rating associated with the online id and allow a user to access the credibility rating.

21. The computer program product of claim 20 further comprising:
a computer useable medium having computer readable code device embodied therein for causing a computer to allow an owner of the online id to formulate the credibility rating for the online id, the computer readable code device in the computer program product comprising:
a computer readable program code device for causing a computer to allow the owner of the online id to input information into the system that can be validated and write the information into a credibility database wherein the information is stored and associated with the online id;
a computer readable program code device for causing a computer to verify that the input by the owner is correct and determine the credibility rating based on the input; and
a computer readable program code device for causing a computer to allow a third party to access the credibility rating stored in the credibility rating system.

22. An article of manufacture comprising:
a computer useable medium having a computer readable program code device embodied therein for causing a computer to associate a credibility rating with a document located in an online search, the computer readable code device in the article of manufacture comprising:
a computer readable program code device for causing a computer to retrieve the document from an information source;
a computer readable program code device for causing a computer to determine an online id associated with the document; and
a computer readable program code device for causing a computer to retrieve a credibility rating associated with the online id and allow a user to access the credibility rating.

23. The article of manufacture of claim 22 further comprising:
a computer useable medium having a computer readable program code device embodied therein for causing a computer to allow an owner of the online id to develop a credibility rating profile for the online id, the computer readable code device in the article of manufacture comprising:
a computer readable program code device for causing a computer to allow the owner of the online id to input information into the system that can be validated and write the information into a credibility database wherein the information is stored and associated with the online id;
a computer readable program code device for causing a computer to verify that the input by the owner is correct and to determine the credibility rating relative to the input; and
a computer readable program code device for causing a computer to allow a third party to access the credibility rating stored in the credibility rating system.
